(19) United States
(12) Patent Application Publication
(10) Pub. No.: US 2025/0245512 A1
(43) Pub. Date: Jul. 31, 2025

(54) HOLISTIC LAYOUT, VECTORIZATION, AND QUANTIZATION FOR LARGE LANGUAGE MODELS

(71) Applicant: QUALCOMM Incorporated, San Diego, CA (US)

(72) Inventor: Alexander Julian REINKING, Somerville, MA (US)

(21) Appl. No.: 18/429,256

(22) Filed: Jan. 31, 2024

(51) Int. Cl. G06N 3/0895

(52) U.S. Cl. CPC G06N 3/0895

(57) ABSTRACT

A processor-implemented method includes receiving a machine learning (ML) model. The ML model has multiple layers and includes a weight matrix in a first format arranged in memory in a first layout. The weight matrix is decomposed into a second format. The decomposed weight matrix is linearized such that each vector block of the weight matrix is contiguous in the memory. The weights of the decomposed weight matrix of the ML model are quantized based on a scaling factor.

### FIELD OF THE DISCLOSURE

Aspects of the present disclosure generally relate machine learning, and more particularly to a holistic layout, vectorization, and quantization for large language models.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Large-scale models such as large language models (LLMs), large vision models (LVMs), or their combinations have grown in popularity because of their ability to recognize, summarize, translate, predict, and generate content. LLMs and LVMs are deep learning models including transformer networks that may learn context and meaning by tracking relationships in sequential input data, such as words in a sentence or images in a video.

Given the many useful applications of large-scale models, there is also increasing demand for use thereof on edge devices, such as smartphones. However, large-scale models use very large data sets with hundreds of billions of examples to train several hundred billion parameters. As a result, training and deployment of such large-scale models on edge devices may be challenging and expensive.

### SUMMARY

The present disclosure is set forth in the independent claims, respectively. Some aspects of the disclosure are described in the dependent claims.

In some aspects of the present disclosure, a processor-implemented method performed by one or more processors includes receiving a machine learning (ML) model having multiple layers and including weights in a first format arranged in the at least one memory in a first layout. The processor-implemented method also includes decomposing the weight matrix into a second format. The processor-implemented method additionally includes linearizing the decomposed weight matrix such that each vector block of the weight matrix is contiguous in the at least one memory. The processor-implemented method further includes quantizing the weights of the decomposed weight matrix of the ML model based on a scaling factor.

Various aspects of the present disclosure are directed to an apparatus including means for receiving a machine learning (ML) model having multiple layers and including weights in a first format arranged in a memory of at least one memory in a first layout. The apparatus also includes means for decompose the weight matrix into a second format. The apparatus additionally includes means for linearizing the decomposed weight matrix such that each vector block of the weight matrix is contiguous in the memory. The apparatus further includes means for quantizing the weights of the decomposed weight matrix of the ML model based on a scaling factor.

Some aspects of the present disclosure are directed to an apparatus having at least one memory and one or more processors coupled to the at least one memory. The processor(s) is configured to receive a machine learning (ML) model having multiple layers and including weights in a first format arranged in the at least one memory in a first layout. The processor(s) is also configured to decompose the weight matrix into a second format. The processor(s) is additionally configured to linearize the decomposed weight matrix such that each vector block of the weight matrix is contiguous in the memory. The processor(s) is further configured to quantize the weights of the decomposed weight matrix of the ML model based on a scaling factor.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary deep convolutional network (DCN), in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a block diagram illustrating an example transformer architecture, in accordance with various aspects of the present disclosure.

FIG. 6A is a diagram illustrating a representation of an operation of an attention block using loops, in accordance with various aspects of the present disclosure.

FIG. 6B is a graph of the indices i and j for the loops shown in FIG. 6A, in accordance with various aspects of the present disclosure.

FIGS. 7A and 7B are diagrams illustrating an example block linearization for quantized matrix multiplication, in accordance with various aspects of the present disclosure.

FIG. 8 is a block diagram illustrating an example block linearization, in accordance with various aspects of the present disclosure.

FIG. 9 is a block diagram illustrating an example vectorized computation of dot product elements, in accordance with various aspects of the present disclosure.

FIG. 10 is a flow diagram illustrating a processor-implemented method for optimization of layout and vectorization, and quantization for large language models, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, large-scale models such as large language models (LLMs), large vision models (LVMs), or their combinations have grown in popularity and there is increasing demand for deploying such models on edge devices as well as in cloud computing systems. In such a constrained environment, deployment of LLMs may involve careful utilization of the processor and memory system to perform well.

The performance of two linear algebra operators may determine the overall performance of an LLM, namely matrix-matrix multiplication (matmul) and matrix-vector (matvec) operations. Prompt processing in LLMs may depend on matmul, and token generation may depend on matvec. While matmul performance has been the subject of investigation, matvec may be viewed as a less interesting case. However, the utility of LLMs may depend on efficient token generation, and therefore on matvec. The matvec operators may have different performance characteristics than the matmul operators. Both operators process O(n²) data, but while matmul has O(n³) arithmetic operations to schedule, matvec has only O(n²) operations to schedule. Hence, optimizing matvec may involve reducing both the footprint (the total size of the programs working set) and access frequency (the number of times a weight is reloaded).

One technique for reducing the footprint of LLMs is quantization. Quantization is a form of lossy compression. Quantization constrains an input from a continuous set of values to a more discrete set of values (e.g., integer values). However, the performance benefits may be offset by the loss of model accuracy and the cost of de-quantization.

Aspects of the present disclosure are directed to a holistic approach to quantization and vectorization. In various aspects, deep learning operators may be written as compiler-friendly loop-based kernels, and the dataflow between operators may be encoded through data dependencies. As a result, machine learning (ML) architectures, such as transformers that manipulate tensors, may be expressed as loops processing multi-dimensional arrays.

Particular aspects of the subject matter described in this disclosure can be implemented to realize one or more of the following potential advantages. In some examples, the described techniques (e.g., representing ML models as computation loops, linearizing blocks of weights, arranging quantized blocks in the z-ordering layout, and/or performing matrix multiplication using a signed integer dot product (SDOT) operation in a broadcast mode) may reduce memory access frequency to reduce model latency and memory footprint.

Moreover, various aspects of the present disclosure may enable direct LLM implementation. That is, by building computation using loops and basic control flow, graph-less representation of the LLM may be achieved. As such, overhead associated with graph management may be significantly reduced. For instance, LLMs may be defined using on the order of 500 lines of code as compared to 80,000 nodes in a graph-based model, for example. Furthermore, expressing the LLM using loops may enable deep compiler analysis and optimization using polyhedral compiler analysis techniques.

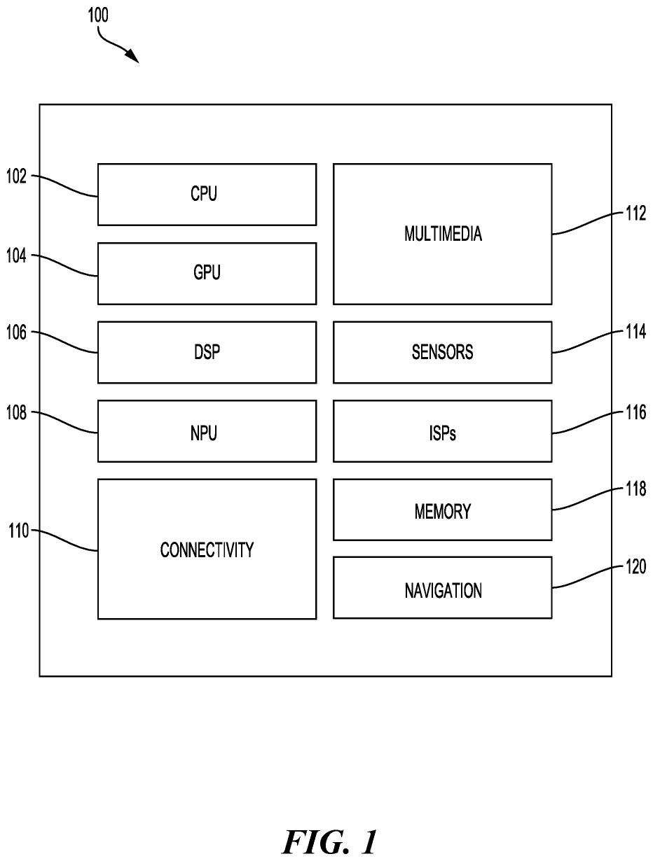

FIG. 1 illustrates an example implementation of a system-on-a-chip (SOC) 100, which may include a central processing unit (CPU) 102 or a multi-core CPU configured for joint optimization of layout and vectorization and quantization in machine learning models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive a machine learning (ML) model. The ML model has multiple layers and includes weights in a first format arranged in a memory of at least one memory in a first layout. The instructions loaded into the general-purpose processor 102 may also include code to decompose the weight matrix into a second format. The instructions loaded into the general-purpose processor 102 may additionally include code to linearize the decomposed weight matrix such that each vector block of the weight matrix is contiguous in the memory. The instructions loaded into the general-purpose processor 102 may further include code to quantize the weights of the decomposed weight matrix of the ML model based on a scaling factor.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

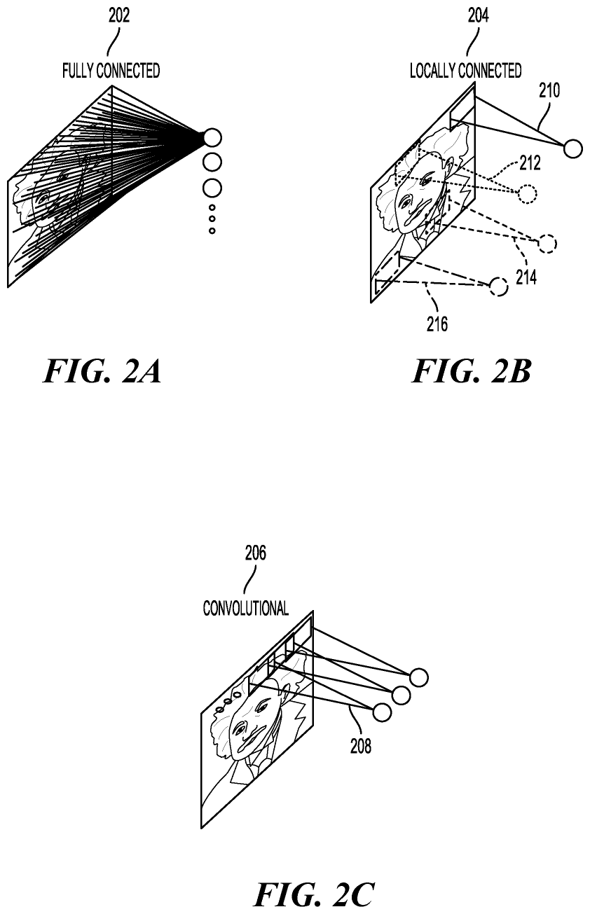

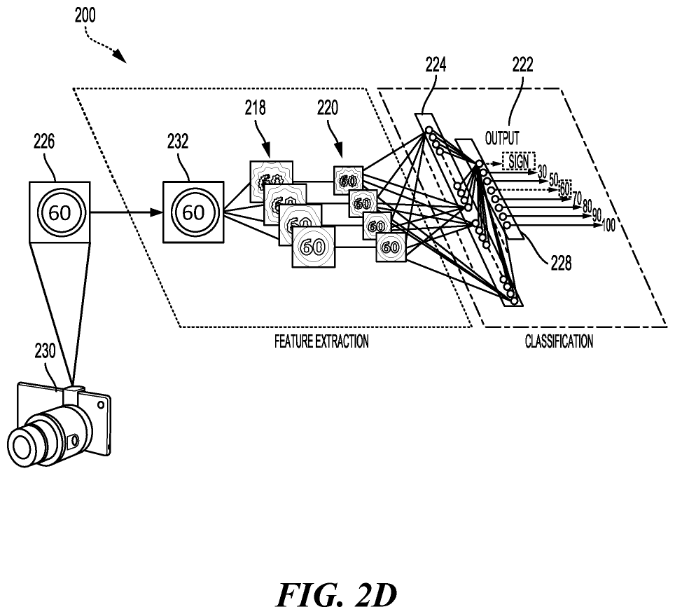

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14x14, is less than the size of the first set of feature maps 218, such as 28x28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

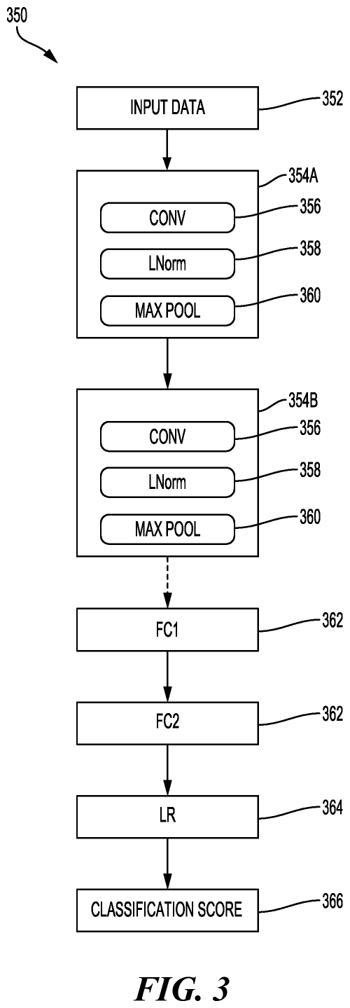

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

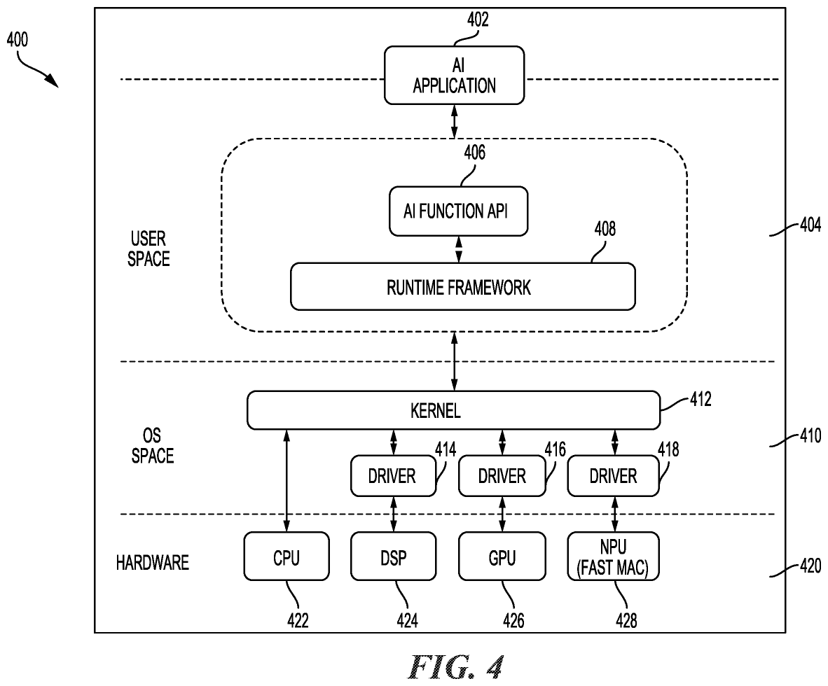

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support optimization of layout as well as vectorization and quantization in machine learning models for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

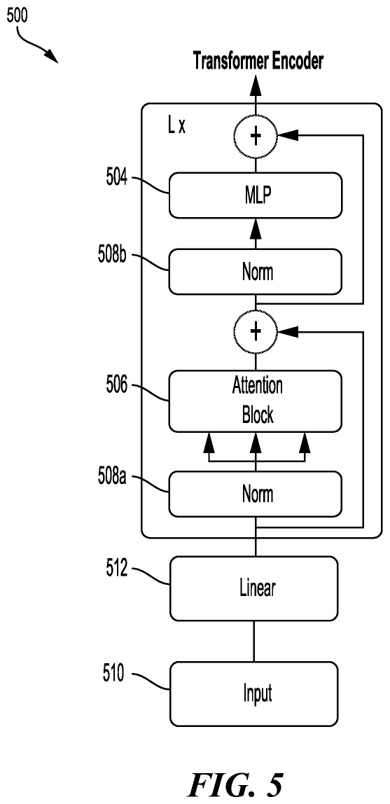

FIG. 5 is a block diagram illustrating an example transformer architecture 500, in accordance with various aspects of the present disclosure. The example transformer architecture 500 may include alternating layers of attention blocks 506 and multi-layer perceptron (MLP) blocks 504. A layer norm block 508 (e.g., 508a, 508b) may be applied before every block of the transformer architecture 500. The attention blocks 506 and MLP blocks 504 may each include a residual connection.

The example transformer architecture 500 may receive an input 510 such as sequential data. In some examples, the sequential data may include (but is not limited to) a sequence of characters or textual data (e.g., a sentence) or audio data, for instance. The transformer architecture 500 may divide the input 510 into portions or tokens (e.g., words).

The tokens may be further processed, for example, via a linear layer 512, which generates a sequence of linear embeddings. In some aspects, positional embeddings may be added to the linear embeddings to tokens with positional embeddings. The linear embeddings may be normalized via the layer norm block 508 and provided to the attention block 506.

The attention block 506 may implement self-attention or multi-head attention to determine relationships among the embeddings for each token. That is, the attention block 506 may assign different attention weights to different portions of the sequence of embeddings corresponding to the tokens. The output of the attention block 506 may be provided to the MLP block 504 and processed to generate an output inference such as a classification, for example.

As described, aspects of the present disclosure are directed to a holistic approach to joint optimization of layout and quantization and vectorization in machine learning (ML) models such as large language models (LLMs). In various aspects, the ML model may be represented using loops such as polyhedral loops, for example, rather than using graphs to represent the ML model. In doing so, a compiler may be enabled to discover tiling and fusion opportunities automatically. In addition, various loop optimizations may be implemented to reduce latency related to layout, quantization and vectorization. In some aspects, such kernels may be jointly optimized.

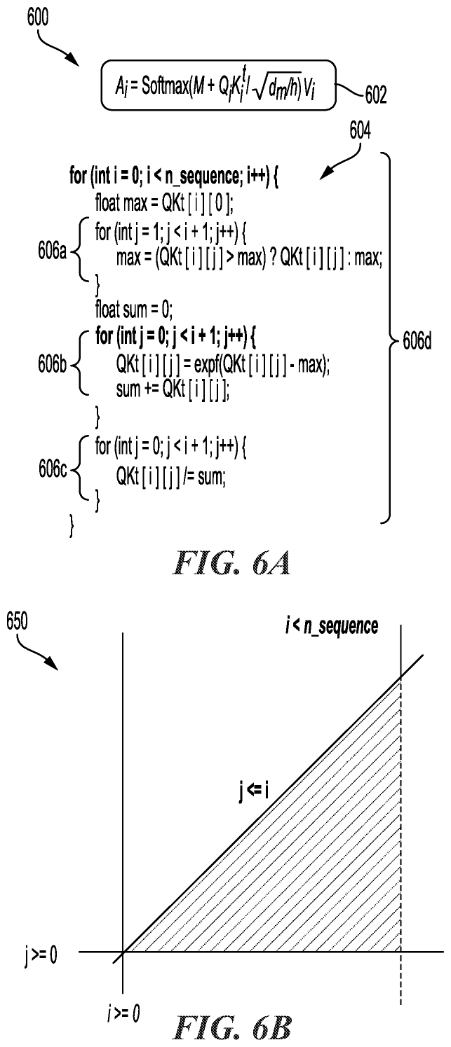

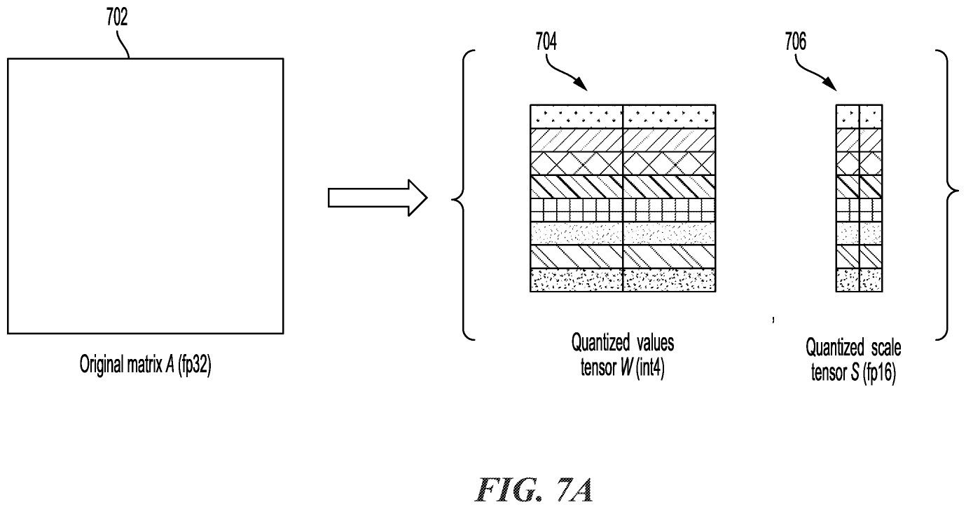

ML models, such as a LLMs, include loops that are polyhedral loops. Polyhedral loops refers to programming loops that are bounded by linear constraints. FIG. 6A is a diagram 600 illustrating the representation of an operation 602 of the attention block 506 using loops, in accordance with various aspects of the present disclosure. Referring to FIG. 6A, the operation 602 for generating an attention matrix Aᵢ performed via the attention block 506 is shown. The operation 602 is expressed as Aᵢ=Softmax(M+QᵢKᵢ^{t}\sqrt{dₘ/h})Vᵢ, where M represents the attention mask (may include infinity values for parts of the context beyond the token being predicted), Qᵢ represents queries, Kᵢ^{t} represents keys, Vᵢ represents values, dₘ represents the size of an embedding vector, and h represents the number of attention heads. The operation 602 may be represented by a set of nested loops 606a-606d of programming code 604.

FIG. 6B is a graph 650 of the indices i and j for the loops 606a-606d. The graph 650 graphically illustrates linear constraints of indices of the loops of the programming code 604. Because the loops are bounded by linear constraints (e.g., the indices i and j), the loops 606a-606d may be considered polyhedral loops. Beneficially, polyhedral compilers may analyze, and in some aspects optimize, geometrical loops including polyhedral loops. Accordingly, by representing the computation of the ML models using loops, the operations of the ML models may be scheduled in a manner that reduces latency, memory footprint, and memory consumption, for example.

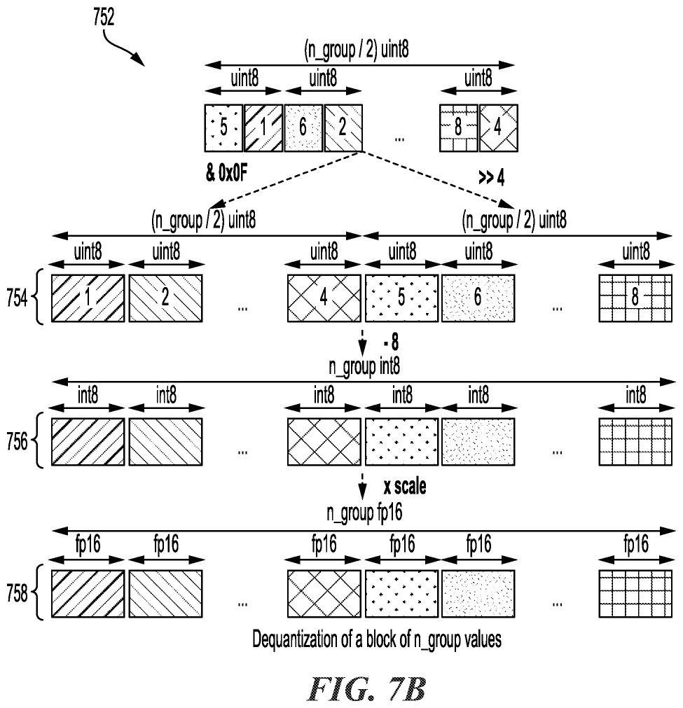

FIGS. 7A and 7B are diagrams illustrating an example block linearization for quantized matrix multiplication, in accordance with various aspects of the present disclosure. Quantized matrix multiplication operations may be frequently performed in ML models. For instance, quantized matrix multiplication may be performed in prompt processing, text generation, as well as quantization and de-quantization. The matrix multiplication operations may include matrix-matrix multiplication (matmul) and matrix-vector (matvec) operations, for instance. The quantized matrix multiplication operation may be a time-consuming operation in ML models. To reduce latency involved with matrix multiplication operations, aspects of the present disclosure provide a packing strategy for storing the matrices in memory.

Referring to FIG. 7A, an original attention matrix A 702 may be decomposed into quantized weight tensors W 704 and quantized scale tensors S 706. The original attention matrix A 702 may, for example (but not limitation), be in a thirty-two-bit floating point format (FP32). Each of the quantized weight values W 704 may be in four-bit integer (INT4) format, and each of the quantized scale tensors S 706 may be in sixteen-bit floating point (FP16) format.

Referring to FIG. 7B, each of the quantized blocks may be stored in memory. For each quantized block, a packing strategy may be implemented to store the quantized block in memory. For example, the quantized weight tensors W 704 may be stored in memory by taking a latter half of the block and storing the higher bits of an 8-bit integer (INT8) location 752 in logical order and storing the lower half of the block in the lower bits of the INT8 location 752 in logical order. For instance, if the quantized block included weight values {1 2 3 4 5 6 7 8}, the quantized block may be split into two halves {1 2 3 4} and {5 6 7 8} and may be stored as {5 1} {6 2} {7 3} {8 4}.

The attention matrix A 702 may be converted into its quantized representation in a block-wise manner. For each block (e.g., 4×32 submatrices of A), a value L may be identified with the greatest magnitude (L may be negative) and each value in the blocks may be multiplied by 8/L (or 1 if L=0). As such, the values in the blocks may all be in the range [−8,8]. A value of 7.5, for example (but not limitation), may be added to each value in the blocks to obtain the range [−0.5,15.5]. Each value may be rounded into the integer range [0, 15], which is the range of UINT4 values and may be packed in memory.

The attention mask M may be applied via a vector instruction (e.g., vandq_u8). A source vector may be formatted as 16 uint8 values. At 754, applying the attention mask (e.g., 0x0F=0b00001111) to all lanes of the source vector may produce a target vector where each of the 16 UINT8 lanes of the target vector may be a copy of the bottom four bits of the corresponding source lane. A right shift by 4 (e.g., vshrq_u8) similarly may produce a second target vector with the top four bits. Then, at 756, the two target vectors may be reinterpreted as signed values and the value 8 (which is half the range of a UINT4) may be subtracted arithmetically such that the INT4 values may be packed in INT8 register. At 756, the values in each block may be multiplied by the scale (e.g., x scale) to dequantized the values in INT8 format to FP16 format.

Accordingly, in some aspects, the process flow of FIG. 7B may pack a pair of UINT4 values in a UINT8 register. The UINT4 represented by upper bits of the UINT8 may be right shifted and loaded into vector registers. Then, each vector register may be unpacked by applying the attention mask and shift by subtracting 8 to convert the values from UINT4 format to INT4 format. The attention mask may be applied to UINT4 represented by lower bits of UINT8. The UINT4 represented by the lower bits may then reinterpreted as signed values and the value 8 (which is half the range of a UINT4) may be subtracted arithmetically such that the INT4 values may be packed in INT8 register.

In some aspects, the second target vector of the two unpacked target vectors may be the same as the source vector. As such the source vector may be discarded or evicted to a main memory, for example.

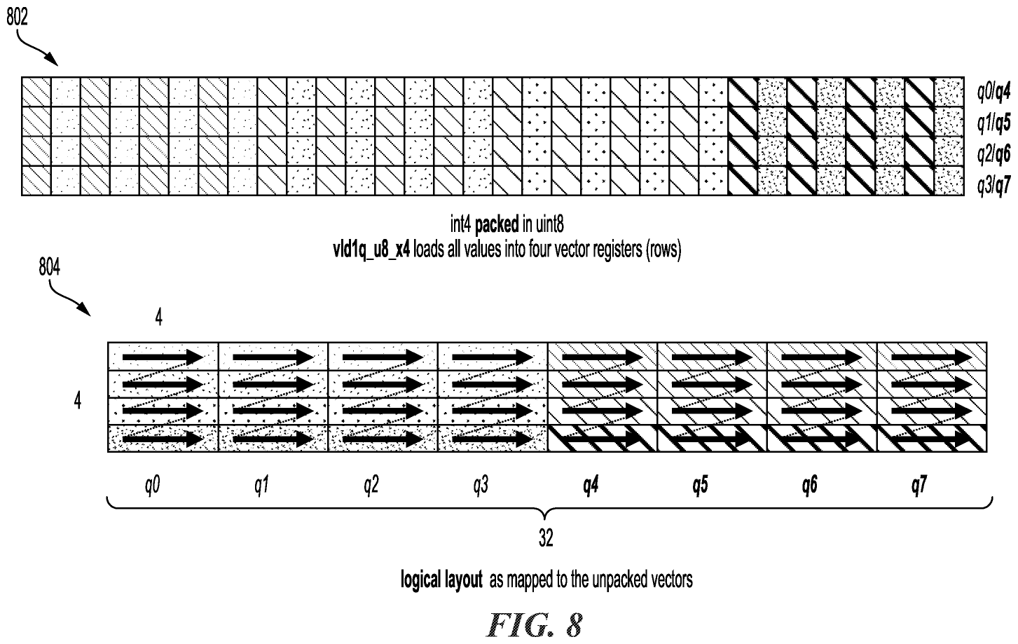

FIG. 8 is a block diagram illustrating an example block linearization, in accordance with various aspects of the present disclosure. Referring to FIG. 8, a memory block of data 802 is stored in memory. The block of data may include four-bit integers (e.g., quantized weight values W) packed in an eight-bit integer register. Each row of the data 802 may include four vector registers, for example. The data 802 may be re-arranged using z-ordering such that four-bit x four-bit sub blocks (e.g., q0-q7) may be consecutive in memory in re-arranged data 804. In z-ordering, the data may be re-arranged to co-locate related data in the same sub-block, for example. The re-arranged data 804 may be in a logical order within each sub-block with each sub-block mapped to an unpacked vector (e.g., weight vector). In some aspects, register tiling may be implemented for performing dot products on the four-bit x four-bit sub-blocks.

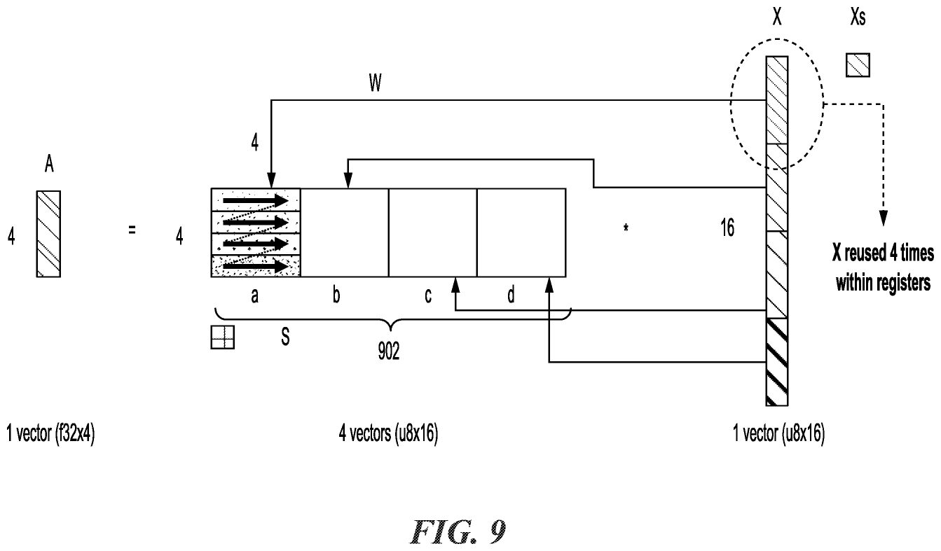

FIG. 9 is a block diagram illustrating an example vectorized computation of dot product elements, in accordance with various aspects of the present disclosure. Referring to FIG. 9, a matrix vector (matvec) operation may be computed as A=W*X, where W is a weight matrix in a layout with z-ordering (may be referred to as the “z4 layout”) as described in FIG. 8, and X is a vector quantized in 32×1 blocks to unsigned 8-bit integer (UINT8) precision. In each iteration of a microkernel, a single instruction may load a 4×32 quantization block from W into four vectors 902. Each vector may be unpacked, for example in two instructions: a shift to the right by four bits to restore the higher-indexed vector block and a mask by 0b00001111 to restore the lower-indexed vector block. As such, eight vectors may be formed with each vector containing a 4×4 vector block. In some aspects, two vectors may be loaded from X in a single instruction. Finally, quantization scales (e.g., S and Xs) may be loaded for both W and X. A signed integer dot product (SDOT) instruction may be executed to compute the respective products. The SDOT instruction may provide a broadcasting mode that uses one of the four vector blocks 902 (e.g., 902a-902d) within a 16-element UINT8 vector (e.g., the vectors loaded from X) as though replicated across the other three quadruples to compute a 4×4*4×1 matvec in a single instruction. In some aspects, eight such SDOTs may be performed concurrently, one for each pair of corresponding vector-blocks from W and quadruples from X. As a result, vector re-loading to execute the matvec operation may be significantly reduced (e.g., by 75 percent) compared to conventional approaches.

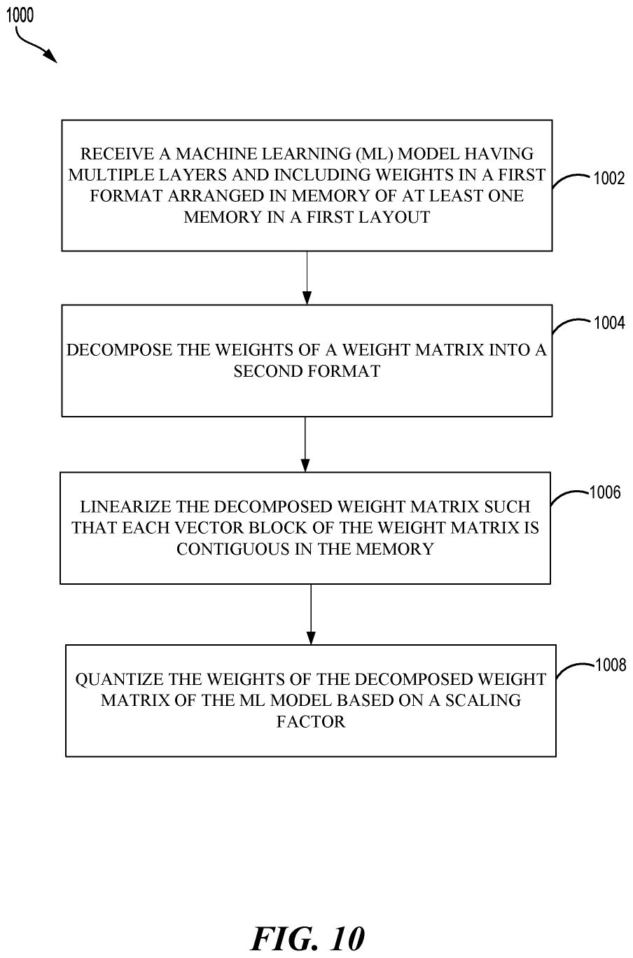

FIG. 10 is a flow diagram illustrating a processor-implemented method 1000 for optimization of layout and vectorization, and quantization for large language models, in accordance with various aspects of the present disclosure. The processor-implemented method 1000 may be performed by one or more processors such as the CPU (e.g., 102, 422), GPU (e.g., 104, 426), and/or other processing unit (e.g., DSP 424, NPU 428), for example.

At block 1002, the one or more processors receive a machine learning (ML) model having multiple layers and including weights in a first format arranged in the at least one memory in a first layout. The machine learning model may comprise a transformer model such as a large language model, a generative pre-trained transformer (GPT) model or other machine learning model, for instance.

At block 1004, the one or more processors decompose the weight matrix into a second format. For instance, as described with reference to FIG. 7A, an original attention matrix A 702 may be decomposed into quantized weight tensors W 704 and quantized scale tensors S 706. The original attention matrix A 702 may, for example (but not limitation), be in a thirty-two-bit floating point format (FP32). Each of the quantized weight values W 704 may be in four-bit integer (INT4) format, and each of the quantized scale tensors S 706 may be in sixteen-bit floating point (FP16) format.

At block 1006, the one or more processors linearize the decomposed weight matrix such that each vector block of the weight matrix is contiguous in the at least one memory. As described, for example, with reference to FIG. 7B, for each quantized block, a packing strategy may be implemented to store the quantized block in memory. For example, the quantized weight tensors W 704 may be stored in memory by taking a latter half of the block and storing the higher bits of an 8-bit integer (INT8) location 752 in logical order and storing the lower half of the block in the lower bits of the INT8 location 752 in logical order.

At block 1008, the one or more processors quantize the weights of the decomposed weight matrix of the ML model based on a scaling factor. As described, for instance, with reference to FIG. 7B, the attention matrix A 702 may be converted into its quantized representation in a block-wise manner. For each block (e.g., 4×32 submatrices of A), a value L may be identified with the greatest magnitude (L may be negative) and each value in the blocks may be multiplied by 8/L (or 1 if L=0). As such, the values in the blocks may all be in the range [−8,8]. A value of 7.5, for example (but not limitation), may be added to each value in the blocks to obtain the range [−0.5,15.5]. Each value may be rounded into the integer range [0, 15], which is the range of UINT4 values and may be packed in memory.

Implementation examples are provided in the following numbered clauses.

1. An apparatus comprising:
at least one memory; and
at least one processor coupled to the at least one memory, the at least one processor configured to:
   receive a machine learning (ML) model having multiple layers and including weights in a first format arranged in the at least one memory in a first layout;
   decompose the weights of a weight matrix into a second format;
   linearize the decomposed weight matrix such that each vector block of the weight matrix is contiguous in the at least one memory; and
   quantize the weights of the decomposed weight matrix of the ML model based on a scaling factor.
      2. The apparatus of clause 1, in which the at least one processor quantizes the weights using a signed integer dot product in a broadcast mode.
      3. The apparatus of clause 1 or 2, in which the first layout comprises a z-ordering layout.
      4. The apparatus of any of clauses 1-3, in which the first format comprises a four-bit integer and weight values are packed in an eight-bit integer format and stored in the at least one memory.
      5. The apparatus of any of clauses 1-4, in which a first portion of the weight values includes a higher indexed block of values and a second portion of the weight values includes a lower indexed block of values, the higher indexed block of values and the lower indexed block of values are arranged logically in memory.
      6. The apparatus of any of clauses 1-5, in which the ML model comprises a large language model (LLM) and the at least one processor is further configured to:
receive, by the LLM, a prompt;
generate, by the LLM, one or more tokens based on the prompt; and
process, by the LLM, the one or more tokens to generate an inference based on the quantized weights.
   7. The apparatus of any of clauses 1-6, the at least one processor being further configured to represent the ML model computation using polyhedral loops.
   8. A processor-implemented method performed by one or more processor, the processor-implemented method comprising:
receiving a machine learning (ML) model having multiple layers and including weights in a first format arranged in memory of at least one memory in a first layout;
decomposing the weights of a weight matrix into a second format;
linearizing the decomposed weight matrix such that each vector block of the weight matrix is contiguous in the memory; and
quantizing the weights of the decomposed weight matrix of the ML model based on a scaling factor.
   9. The processor-implemented method of clause 8, further comprising quantizing the weights using a signed integer dot product in a broadcast mode.
   10. The processor-implemented method of clause 8 or 9, in which the first layout comprises a z-ordering layout.
   11. The processor-implemented method of any of clauses 8-10, in which the first format comprises a four-bit integer and weight values are packed in an eight-bit integer format and stored in the memory.
   12. The processor-implemented method of any of clauses 8-11, in which a first portion of the weight values includes a higher indexed block of values and a second portion of the weight values includes a lower indexed block of values, the higher indexed block of values and the lower indexed block of values are arranged logically in the memory.
   13. The processor-implemented method of any of clauses 8-12, in which the ML model comprises a large language model (LLM) and further comprising:
receive, by the LLM, a prompt;
generate, by the LLM, one or more tokens based on the prompt; and
process, by the LLM, the one or more tokens to generate an inference based on the quantized weights.
   14. The processor-implemented method of any of clauses 8-13, further comprising representing the ML model computation using polyhedral loops.
   15. An apparatus comprising:
means for receiving a machine learning (ML) model having multiple layers and including weights in a first format arranged in a memory of at least one memory in a first layout;
means for decomposing the weights of a weight matrix into a second format;
means for linearizing the decomposed weight matrix such that each vector block of the weight matrix is contiguous in the memory; and
means for quantizing the weights of the decomposed weight matrix of the ML model based on a scaling factor.
   16. The apparatus of clause 15, further comprising means for quantizing the weights using a signed integer dot product in a broadcast mode.
   17. The apparatus of clause 15 or 16, in which the first layout comprises a z-ordering layout.
   18. The apparatus of any of clauses 15-17, in which the first format comprises a four-bit integer and weight values are packed in an eight-bit integer format and stored in the memory.
   19. The apparatus of any of clauses 15-18, in which a first portion of the weight values includes a higher indexed block of values and a second portion of the weight values includes a lower indexed block of values, the higher indexed block of values and the lower indexed block of values are arranged logically in the memory.
   20. The apparatus of any of clauses 15-19, in which the ML model comprises a large language model (LLM) and further comprising:
means for receiving, by the LLM, a prompt;
means for generating, by the LLM, one or more tokens based on the prompt; and means for processing, by the LLM, the one or more tokens to generate an inference based on the quantized weights.

In one aspect, the receiving means, decomposing means, linearizing means and/or quantizing means may be the CPU (e.g., 102, 422), GPU (e.g., 104, 426), another processing unit (e.g., DSP 424, NPU 428), and/or the dedicated memory block 118, configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus comprising:
at least one memory; and
at least one processor coupled to the at least one memory, the at least one processor configured to:
receive a machine learning (ML) model having multiple layers and including weights in a first format arranged in the at least one memory in a first layout;
decompose the weights of a weight matrix into a second format;
linearize the decomposed weight matrix such that each vector block of the weight matrix is contiguous in the at least one memory; and
quantize the weights of the decomposed weight matrix of the ML model based on a scaling factor.

2. The apparatus of claim 1, in which the at least one processor quantizes the weights using a signed integer dot product in a broadcast mode.

3. The apparatus of claim 1, in which the first layout comprises a z-ordering layout.

4. The apparatus of claim 1, in which the first format comprises a four-bit integer and weight values are packed in an eight-bit integer format and stored in the at least one memory.

5. The apparatus of claim 4, in which a first portion of the weight values includes a higher indexed block of values and a second portion of the weight values includes a lower indexed block of values, the higher indexed block of values and the lower indexed block of values are arranged logically in memory.

6. The apparatus of claim 1, in which the ML model comprises a large language model (LLM) and the at least one processor is further configured to:
receive, by the LLM, a prompt;
generate, by the LLM, one or more tokens based on the prompt; and
process, by the LLM, the one or more tokens to generate an inference based on the quantized weights.

7. The apparatus of claim 1, the at least one processor being further configured to represent the ML model computation using polyhedral loops.

8. A processor-implemented method performed by one or more processor, the processor-implemented method comprising:
receiving a machine learning (ML) model having multiple layers and including weights in a first format arranged in memory of at least one memory in a first layout;
decomposing the weights of a weight matrix into a second format;
linearizing the decomposed weight matrix such that each vector block of the weight matrix is contiguous in the memory; and
quantizing the weights of the decomposed weight matrix of the ML model based on a scaling factor.

9. The processor-implemented method of claim 8, further comprising quantizing the weights using a signed integer dot product in a broadcast mode.

10. The processor-implemented method of claim 8, in which the first layout comprises a z-ordering layout.

11. The processor-implemented method of claim 8, in which the first format comprises a four-bit integer and weight values are packed in an eight-bit integer format and stored in the memory.

12. The processor-implemented method of claim 11, in which a first portion of the weight values includes a higher indexed block of values and a second portion of the weight values includes a lower indexed block of values, the higher indexed block of values and the lower indexed block of values are arranged logically in the memory.

13. The processor-implemented method of claim 8, in which the ML model comprises a large language model (LLM) and further comprising:
receive, by the LLM, a prompt;
generate, by the LLM, one or more tokens based on the prompt; and
process, by the LLM, the one or more tokens to generate an inference based on the quantized weights.

14. The processor-implemented method of claim 8, further comprising representing the ML model computation using polyhedral loops.

15. An apparatus comprising:
means for receiving a machine learning (ML) model having multiple layers and including weights in a first format arranged in memory of at least one memory in a first layout;
means for decomposing the weights of a weight matrix into a second format;
means for linearizing the decomposed weight matrix such that each vector block of the weight matrix is contiguous in the memory; and
means for quantizing the weights of the decomposed weight matrix of the ML model based on a scaling factor.

16. The apparatus of claim 15, further comprising means for quantizing the weights using a signed integer dot product in a broadcast mode.

17. The apparatus of claim 15, in which the first layout comprises a z-ordering layout.

18. The apparatus of claim 15, in which the first format comprises a four-bit integer and weight values are packed in an eight-bit integer format and stored in the memory.

19. The apparatus of claim 18, in which a first portion of the weight values includes a higher indexed block of values and a second portion of the weight values includes a lower indexed block of values, the higher indexed block of values and the lower indexed block of values are arranged logically in the memory.

20. The apparatus of claim 15, in which the ML model comprises a large language model (LLM) and further comprising:
means for receiving, by the LLM, a prompt;
means for generating, by the LLM, one or more tokens based on the prompt; and
means for processing, by the LLM, the one or more tokens to generate an inference based on the quantized weights.
